(19) United States
(12) Patent Application Publication
(10) Pub. No.: US 2025/0318986 A1
(43) Pub. Date: Oct. 16, 2025

(54) MASSAGE DEVICE AND MASSAGE EQUIPMENT

(71) Applicant: Yijingxin (Shandong) Medical Device Technology Co., Ltd., Ji’ning (CN)

(72) Inventor: Lei YU, Ji’ning (CN)

(73) Assignee: Yijingxin (Shandong) Medical Device Technology Co., Ltd., Ji’ning (CN)

(21) Appl. No.: 19/177,389

(22) Filed: Apr. 11, 2025

(30) Foreign Application Priority Data
Apr. 11, 2024 (CN) 202420744057.1

(51) Int. Cl. A61H 23/02

(52) U.S. Cl. CPC A61H 23/0254; A61H 2201/0192; A61H 2201/1418

(57) ABSTRACT

The present invention provides a massage device and equipment comprising a drive motor, mounting seat, and swing mechanism. The swing mechanism includes a first curved rotating shaft and multiple first vibration assemblies, each with a cylindrical swing member and first vibration motor. The swing member has a first penetration hole for the shaft and an installation hole for the motor. The mounting seat features a second penetration hole for the shaft and a second vibration assembly. During operation, the swing mechanism's motion and vibration, combined with the seat's second vibration assembly, enable diversified massage operations. This solution ensures user comfort while delivering varied massage modalities, meeting user needs, and enhancing the overall experience.

### CROSS-REFERENCE TO RELATED APPLICATIONS

The application claims priority to Chinese patent application No. 202420744057.1, filed on Apr. 11, 2024, the entire contents of which are incorporated herein by reference.

### TECHNICAL FIELD

The present invention belongs to the technical field of massage products; more specifically, it relates to a massage device and massage equipment.

### BACKGROUND

With the improvement of people's living standards, more and more people choose massagers to relieve physical fatigue. Massagers are a new generation of health equipment developed based on physics, bionics, bioelectricity, traditional Chinese medicine, and years of clinical practice. They can relax muscles, soothe nerves, promote blood circulation, enhance cell metabolism, improve skin elasticity, relieve fatigue, significantly reduce various chronic pain, acute pain, and muscle soreness, relax the body to reduce stress, and reduce skin wrinkles. Currently, the market offers a wide variety of equipment for human body massage with comprehensive functions; massage beds alone include various functions such as rolling massage, vibration massage, far-infrared heating massage, and magnetic therapy massage, allowing people to enjoy the comfort and pleasure brought by massage after intense work.

Vibrating massagers are among the most common types of massage equipment; their most notable feature is generating high-frequency vibrations to massage the human body, which can relieve physical fatigue. Due to irregularities in female sexual life, which have affected personal and family harmony and happiness to varying degrees, sexual function auxiliary massagers for women on the market can compensate for these shortcomings and bring more pleasure to life. However, the functions of sexual function auxiliary massagers in the prior art are relatively singular, only able to meet user needs by changing the shape, vibration frequency, and vibration mode of the massager, resulting in a singular experience and failing to provide users with a better user experience.

### SUMMARY

The purpose of the present invention is to provide a massage device to solve the technical problem in the prior art where massage devices have relatively single functionality, merely satisfying user needs by changing the shape, vibration frequency and vibration mode of the massage device, resulting in monotonous experience and inability to provide users with better user experience.

To achieve the above purpose, the technical solution adopted by the present invention is: providing a massage device for massage equipment. The massage device comprises a drive motor, a mounting seat, and a swing mechanism disposed between the drive motor and the mounting seat. The drive motor has a first output shaft. The swing mechanism includes a first curved rotating shaft and multiple first vibration assemblies disposed on the first curved rotating shaft. One end of the first curved rotating shaft is fixedly connected to the first output shaft, while the other end is rotatably connected to the mounting seat. Each first vibration assembly includes a swing member sleeved on the first curved rotating shaft and a first vibration motor disposed on the swing member. The swing member is cylindrical in shape and is provided with a first through-hole for the first curved rotating shaft to penetrate through, as well as a mounting hole for installing the first vibration motor. The mounting seat is provided with a second through-hole for the first curved rotating shaft to penetrate through, and a second vibration assembly is disposed on the side of the mounting seat opposite to the side facing the drive motor.

In one embodiment, the swing mechanism further comprises soft rubber pads disposed between adjacent swing members; the soft rubber pads are penetrated with third penetration holes for the first curved rotating shaft to pass through.

In one embodiment, the massage device further comprises a limit rod disposed between the drive motor and the mounting seat; the swing member is penetrated with a first oblong hole for the limit rod to pass through.

In one embodiment, there are two limit rods; the swing member is penetrated with two first oblong holes; the two first oblong holes are symmetrically arranged on both sides of the first penetration hole; the two limit rods respectively penetrate through the two first oblong holes.

In one embodiment, the massage device further comprises a second curved rotating shaft; one end of the second curved rotating shaft is fixedly connected to the first curved rotating shaft, and the other end is fixedly connected to the second vibration assembly.

In one embodiment, the massage device further comprises an eccentric transmission assembly and an activity assembly disposed between the mounting seat and the second vibration assembly; the eccentric transmission assembly comprises a support frame fixed to the mounting seat, an eccentric cam fixed to the first curved rotating shaft, and a transmission rod fixed to the eccentric cam; the activity assembly comprises a movable frame rotatably disposed on the support frame and a swing arm disposed on the movable frame; the transmission rod is slidably connected to the movable frame, and the swing arm is fixedly connected to the second vibration assembly.

In one embodiment, one end of the transmission rod is provided with a fixed part fixedly connected to the eccentric wheel, and the other end is provided with a sliding part slidably connected to the moving frame. The moving frame is provided with a slide rail for slidably connecting with the transmission rod, and the sliding part is penetrated with a connection hole for the slide rail to pass through.

In one embodiment, the massage device further comprises a telescopic rotating motor disposed between the mounting seat and the second vibration assembly; the telescopic rotating motor has a second output shaft fixedly connected to the second vibration assembly.

In one embodiment, the second vibration assembly comprises a mounting housing fixed to the mounting seat and a second vibration motor disposed within the mounting housing.

The beneficial effects of the massage device provided by the present invention are: compared with prior art, this massage device for massage equipment comprises a drive motor, mounting seat, and swing mechanism between them; the drive motor has a first output shaft; the swing mechanism comprises a first curved rotating shaft and multiple first vibration assemblies thereon; one end of the first shaft connects to the first output shaft while the other end rotatably connects to the mounting seat; each first vibration assembly comprises a cylindrical swing member sleeved on the first shaft and a first vibration motor thereon; the swing member has a first penetration hole for the first shaft and an installation hole for the motor; the mounting seat has a second penetration hole for the first shaft and a second vibration assembly opposite the drive motor side. The drive motor provides the kinetic energy required for the operation of the massage device. The swing mechanism is arranged between the drive motor and the mounting seat. One end of the first curved rotating shaft of the swing mechanism is fixedly connected to the first output shaft of the drive motor, while the other end penetrates the second penetration hole of the mounting seat and is rotatably connected to the mounting seat. When the drive motor starts operating, the first curved rotating shaft rotates with the rotation of the first output shaft. The first curved rotating shaft penetrates the first penetration holes of the swing members of multiple first vibration assemblies, causing the multiple swing members sleeved on the first curved rotating shaft to sway accordingly, thereby causing the entire swing mechanism to swing. At the same time, the first vibration motor installed in the mounting hole of the swing member operates and generates vibrations, achieving massage on the target area. The multiple swing members are cylindrical, ensuring a relatively smooth connection between adjacent swing members, which helps maintain user comfort during use. By utilizing the swinging and vibration of the swing mechanism on the massage device, combined with the vibration of the second vibration assembly installed on the mounting seat, the device provides massage to the user. While ensuring user comfort, it offers a more diversified massage experience, meeting user needs and delivering a better user experience.

The purpose of the invention is to provide a massage device to solve the technical problem in the prior art where the functions of massage devices are relatively limited; they can only meet users' needs by changing the shape, vibration frequency, and vibration mode of the massage device, resulting in a monotonous experience that fails to provide users with better usage satisfaction.

To achieve the above purpose, the technical solution adopted by the present invention is: providing a massage equipment comprising a silicone soft shell with an inner cavity and the aforementioned massage device disposed within the silicone soft shell.

The beneficial effects of the massage device provided by the present invention are as follows: Compared with existing technologies, the massage device of the present invention comprises a silicone soft shell with an inner cavity and the aforementioned massage device arranged inside the silicone soft shell. By covering the outer surface of the massage device with the silicone soft shell, on one hand, the surface of the massage device becomes softer and more flexible, enhancing user comfort during use; on the other hand, it provides waterproofing, making the device easier to use and clean, thereby extending its service life. The massage device utilizes the drive motor to supply the kinetic energy required for operation, with the swing mechanism positioned between the drive motor and the mounting seat. One end of the first curved rotating shaft of the swing mechanism is fixedly connected to the first output shaft of the drive motor, while the other end penetrates the second penetration hole of the mounting seat and is rotatably connected to it. When the drive motor starts operating, the first curved rotating shaft rotates along with the first output shaft, and since it passes through the first penetration holes of the swing members of multiple first vibration assemblies, the multiple swing members sleeved on the first curved rotating shaft sway accordingly, causing the entire swing mechanism to swing. Simultaneously, the first vibration motors installed in the mounting holes of the swing members operate and generate vibrations, enabling massage of the target area. The cylindrical shape of the swing members ensures smooth connections between adjacent members, enhancing user comfort. By combining the swinging and vibration of the swing mechanism on the massage device with the vibration of the second vibration assembly on the mounting seat, the device effectively massages the user. While ensuring comfort, it offers diversified massage modes to meet user needs and deliver an improved user experience.

### BRIEF DESCRIPTION OF DRAWINGS

To more clearly illustrate the technical solutions in the embodiments of the present invention, the following briefly introduces the accompanying drawings required for describing the embodiments or the prior art. Obviously, the accompanying drawings in the following description are only some embodiments of the present invention. For those of ordinary skill in the art, other drawings can be obtained based on these accompanying drawings without creative effort.

FIG. 1 is a schematic perspective view of a massage device according to Embodiment 1 of the present invention;

FIG. 2 is a partial schematic perspective view of the massage device according to Embodiment 1 of the present invention;

FIG. 3 is a schematic perspective view of a first vibration assembly of the massage device according to Embodiment 1 of the present invention;

FIG. 4 is a schematic perspective view of a massage device according to Embodiment 2 of the present invention;

FIG. 5 is a schematic perspective view of a massage device according to Embodiment 3 of the present invention. Wherein, marks in the drawings:

1. Drive motor; 11. First output shaft; 2. Mounting seat; 3. Limit rod; 4. Swing mechanism; 41. First curved rotating shaft; 42. First vibration assembly; 421. Swing member; 4211. First penetration hole; 4212. First oblong hole; 422. First vibration motor; 423. Soft rubber pad; 4231. Third penetration hole; 5. Second vibration assembly; 6. Second curved rotating shaft; 7. Eccentric transmission assembly; 71. Support frame; 72. Eccentric cam; 73. Transmission rod; 731. Sliding portion; 8. Movable frame; 81. Sliding rail; 9. Telescopic rotating motor; 91. Second output shaft.

### DETAILED DESCRIPTION OF THE EMBODIMENTS

To make the technical problems, solutions, and beneficial effects of the present invention clearer, the following provides a further detailed description of the present invention with reference to the accompanying drawings and embodiments. It should be understood that the specific embodiments described herein are only used to explain the present invention and not to limit it.

It should be noted that when an element is referred to as being “fixed to” or “disposed on” another element, it can be directly on the other element or indirectly on the other element. When an element is referred to as being “connected to” another element, it can be directly connected to the other element or indirectly connected to the other element.

It should be understood that the orientation or positional relationship indicated by terms such as “length”, “width”, “upper”, “lower”, “front”, “rear”, “left”, “right”, “vertical”, “horizontal”, “top”, “bottom”, “inner”, and “outer” is based on the orientation or positional relationship shown in the accompanying drawings. These terms are used only for ease of describing the present invention and simplifying the description, and do not indicate or imply that the referred device or element must have a specific orientation or be constructed and operated in a specific orientation. Therefore, they should not be construed as limiting the present invention.

Furthermore, the terms “first” and “second” are used for descriptive purposes only and should not be construed as indicating or implying relative importance or implicitly specifying the quantity of the indicated technical features. Thus, features defined as “first” or “second” may explicitly or implicitly include one or more of such features. In the description of the present invention, “multiple” means two or more unless explicitly specified otherwise.

### Embodiment 1

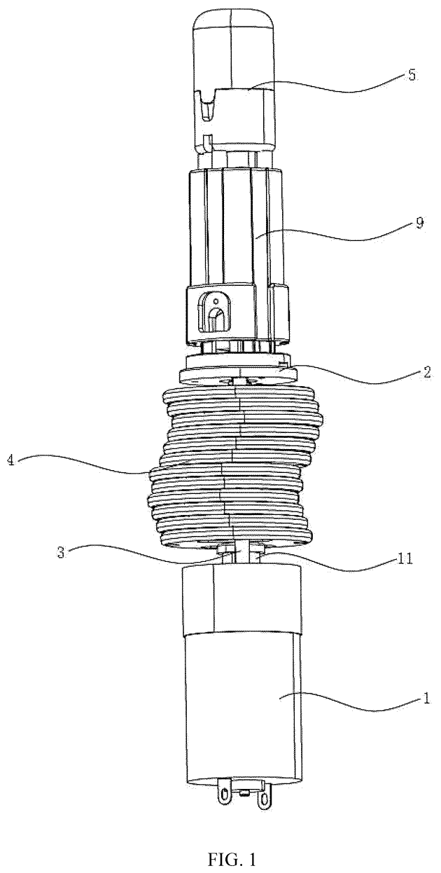

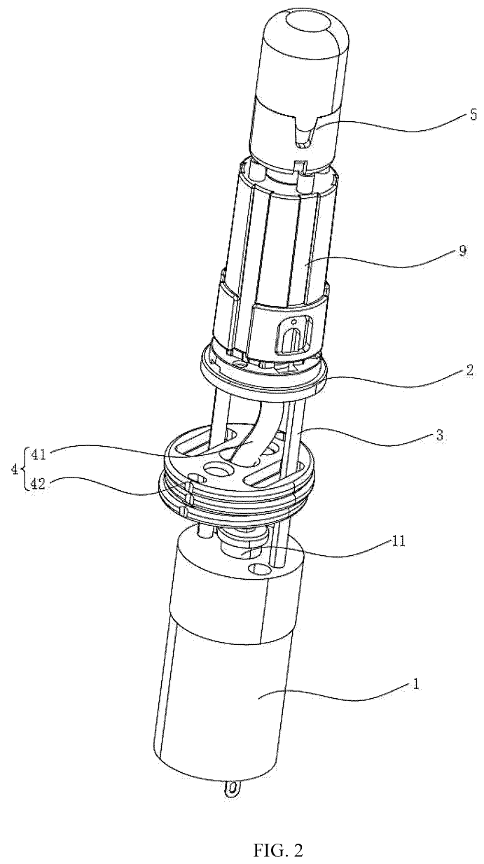

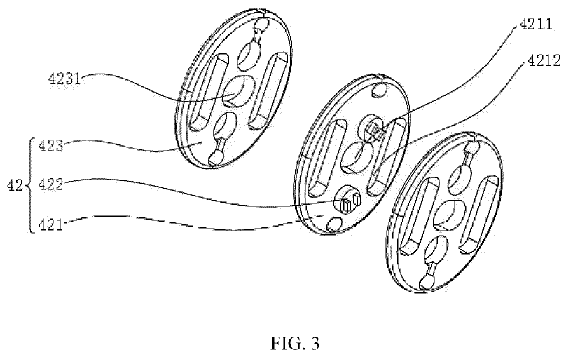

Referring to FIGS. 1 to 3. Embodiment 1 of the present invention provides a massage device for massage equipment. The massage device comprises a drive motor 1, a mounting seat 2, and a swing mechanism 4 arranged between the drive motor 1 and the mounting seat 2; the drive motor 1 has a first output shaft 11, and the swing mechanism 4 includes a first curved rotating shaft 41 and multiple first vibration assemblies 42 disposed on the first curved rotating shaft 41; one end of the first curved rotating shaft 41 is fixedly connected to the first output shaft 11, while the other end is rotatably connected to the mounting seat 2; each first vibration assembly 42 comprises a swing member 421 sleeved on the first curved rotating shaft 41 and a first vibration motor 422 disposed on the swing member 421; the swing member 421 is cylindrical and is provided with a first penetration hole 4211 for the first curved rotating shaft 41 to pass through, as well as a mounting hole for installing the first vibration motor 422; the mounting seat 2 is provided with a second penetration hole for the first curved rotating shaft 41 to pass through, and a second vibration assembly 5 is arranged on the side of the mounting seat 2 opposite to the side facing the drive motor 1. The drive motor 1 provides the kinetic energy required for the operation of the massage device; the swing mechanism 4 is arranged between the drive motor 1 and the mounting seat 2, with one end of the first curved rotating shaft 41 of the swing mechanism 4 fixedly connected to the first output shaft 11 of the drive motor 1, and the other end penetrating the second penetration hole of the mounting seat 2 and rotatably connected to it; when the drive motor 1 starts operating, the first curved rotating shaft 41 rotates along with the first output shaft 11, and since the first curved rotating shaft 41 penetrates the first penetration holes 4211 of the swing members 421 of multiple first vibration assemblies 42, the multiple swing members 421 sleeved on the first curved rotating shaft 41 sway accordingly, causing the entire swing mechanism 4 to swing; meanwhile, the first vibration motors 422 installed in the mounting holes of the swing members 421 operate and generate vibrations, enabling massage of the target area; the multiple swing members 421 are cylindrical, ensuring a relatively smooth connection between adjacent swing members 421, which helps enhance user comfort; by utilizing the swinging and vibration of the swing mechanism 4 on the massage device, combined with the vibration of the second vibration assembly 5 installed on the mounting seat 2, the device massages the user; while ensuring user comfort, it provides more diversified massage modes, meets user needs, and delivers a better user experience. The material of the swing member 421 is not limited here; optionally, the swing member 421 may be made of metal or plastic materials with high hardness.

Optionally, the massage device further comprises a limit rod 3 disposed between the drive motor 1 and the mounting seat 2; the swing member 421 is penetrated with a first oblong hole 4212 for the limit rod 3 to pass through; by arranging the limit rod 3 between the drive motor 1 and mounting seat 2 and penetrating multiple swing members 421 through the first oblong holes 4212, the displacement range of the swing members 421 is restricted; this ensures the swing members 421 move within a predetermined swing range, thereby limiting the swing amplitude of the swing mechanism 4 and controlling the force applied by the massage equipment to target areas; this helps ensure user comfort and delivers better user experience.

Optionally, the number of the limit rods 3 is two, and two first oblong holes 4212 are penetratingly arranged on the swing member 421. The two first oblong holes 4212 are symmetrically disposed on both sides of the first penetration hole 4211, and the two limit rods 3 respectively penetrate the two first oblong holes 4212. By symmetrically arranging the two first oblong holes 4212 on both sides of the first penetration hole 4211 of the swing member 421 and having the two limit rods 3 respectively penetrate the two first oblong holes 4212, the transverse movement range of the first vibration assembly 42 relative to the first curved rotating shaft 41 is more comprehensively restricted, ensuring that the swing member 421 moves within a preset swing range. This more comprehensively limits the swing amplitude of the swing mechanism 4, thereby controlling the external force applied by the massage device to the user's target massage area in all directions, more effectively improving user comfort, providing a better user experience, and enhancing the structural stability and reliability of the massage device.

Optionally, the swing mechanism 4 further comprises soft rubber pads 423 disposed between adjacent swing members 421; the soft rubber pads 423 are penetrated with third penetration holes 4231 for the first curved rotating shaft 41 to pass through; by sleeving multiple soft rubber pads 423 on the first curved rotating shaft 41 between adjacent swing members 421, they separate the rigid swing members; when the first vibration motor 422 on a swing member 421 activates, the soft rubber pads 423 effectively prevent direct collision between adjacent rigid swing members 421, reducing noise generation; this helps ensure user comfort and delivers better user experience.

Optionally, the soft rubber pad 423 is penetrated with a second oblong hole for the limit rod 3 to pass through; the position of the second oblong hole on the soft rubber pad 423 corresponds to that of the first oblong hole 4212 on the swing member 421; by penetrating the limit rod 3 through multiple first oblong holes 4212 on swing members 421 and multiple second oblong holes on soft rubber pads 423, the displacement ranges of both swing members 421 and soft rubber pads 423 are restricted; this ensures both components move within predetermined swing ranges, thereby limiting the swing amplitude of swing mechanism 4 and controlling massage force application; this helps ensure user comfort and delivers better user experience.

Optionally, the second vibration assembly 5 comprises a mounting housing fixed to the mounting seat 2 and a second vibration motor disposed within the mounting housing; by placing the second vibration motor inside the mounting housing, vibrations generated by the second vibration motor are transmitted to the mounting housing and then to the external environment; while ensuring user comfort, this configuration protects the second vibration motor during transportation or use, helping to extend the service life of the massage equipment.

Optionally, the massage device further comprises a telescopic rotating motor 9 disposed between the mounting seat 2 and the second vibration assembly 5; the telescopic rotating motor 9 has a second output shaft 91 fixedly connected to the second vibration assembly 5; by connecting the second vibration assembly 5 through the second output shaft 91 of the telescopic rotating motor 9, the mounting housing can not only vibrate under the drive of the second vibration motor but also achieve extension/retraction and rotation under the drive of the telescopic rotating motor 9; while ensuring user comfort, this provides users with more diversified massage methods, meets user needs, and delivers better user experience.

### Embodiment 2

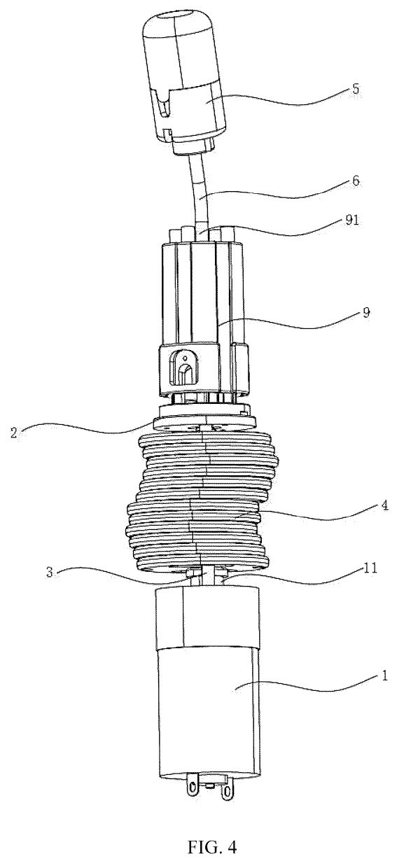

Please refer to FIG. 4. The massage device provided in Embodiment 2 of the invention further includes a second curved rotating shaft 6. One end of the second curved rotating shaft 6 is fixedly connected to the first curved rotating shaft 41, and the other end is fixedly connected to the second vibration assembly 5. When the drive motor 1 starts operating, the first curved rotating shaft 41 rotates along with the rotation of the first output shaft 11, causing multiple swing members 421 sleeved on the first curved rotating shaft 41 to swing accordingly, thereby making the swing mechanism 4 swing as a whole. The first vibration motor 422, installed in the mounting holes of the swing members 421, operates and generates vibrations. At the same time, since the second curved rotating shaft 6 is fixedly connected to the first curved rotating shaft 41, the second curved rotating shaft 6 rotates along with the rotation of the first curved rotating shaft 41, thereby driving the second vibration assembly 5, which is fixedly connected to the second curved rotating shaft 6, to rotate and swing. This allows the mounting housing not only to vibrate under the drive of the second vibration motor but also to rotate and swing under the drive of the second curved rotating shaft 6. While ensuring user comfort, it provides users with more diversified massage modes, meets user needs, and delivers a better user experience.

Optionally, the massage device further comprises a telescopic rotating motor 9 between mounting seat 2 and second vibration assembly 5; the motor 9 has a second output shaft 91 fixed to the second vibration assembly 5; one end of a second curved rotating shaft 6 connects to shaft 91 while the other end connects to assembly 5; when motor 9 operates, shaft 6 extends/retracts and rotates with shaft 91, driving assembly 5 to perform telescopic rotational swings; this allows the housing to not only vibrate via the second vibration motor but also achieve telescopic rotational movements via shafts 91 and 6; while ensuring comfort, this provides diversified massage modes to better meet user needs and experience.

### Embodiment 3

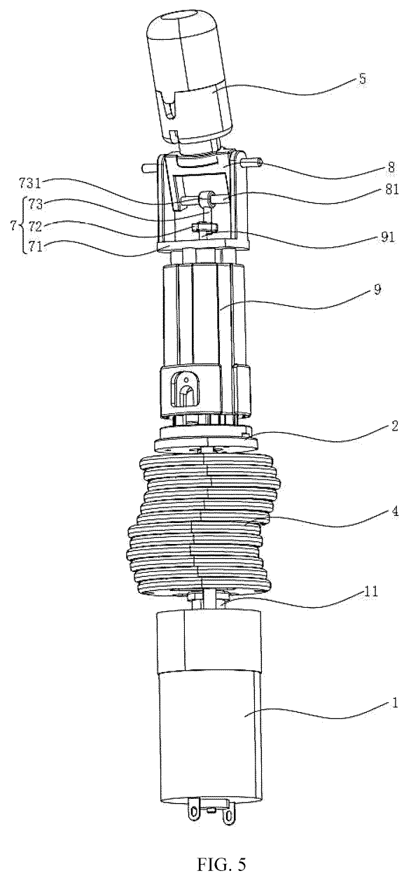

Referring to FIG. 5, a massage device according to Embodiment 3 of the present invention further comprises an eccentric transmission assembly 7 and an activity assembly disposed between the mounting seat 2 and the second vibration assembly 5; the drive motor 1 provides kinetic energy required for operation of the massage device, and the eccentric transmission assembly 7 transmits the kinetic energy to the activity assembly; the activity assembly is fixedly connected to the second vibration assembly 5, causing the second vibration assembly 5 to swing and achieve massage on target areas. The eccentric transmission assembly 7 comprises a support frame 71 fixed to the mounting seat 2, an eccentric cam 72 fixed to the first curved rotating shaft 41, and a transmission rod 73 fixed to the eccentric cam 72; the activity assembly comprises a movable frame 8 rotatably disposed on the support frame 71 and a swing arm disposed on the movable frame 8; the transmission rod 73 is slidably connected to the movable frame 8, and the swing arm is fixedly connected to the second vibration assembly 5; by connecting the first curved rotating shaft 41 and transmission rod 73 via the eccentric cam 72 with their connection points offset, while having the movable frame 8 rotatably connected to the support frame 71 and the transmission rod 73 slidably connected to the movable frame 8. When the drive motor 1 is activated, the first curved rotating shaft 41 drives the eccentric wheel 72 to rotate, causing the connection point between the transmission rod 73 and the eccentric wheel 72 to rotate relative to the support frame 71 with the end of the first curved rotating shaft 41 as the rotation center. Simultaneously, the transmission rod 73 transfers the kinetic energy output by the drive motor 1 to the movable frame 8, allowing the connection point between the transmission rod 73 and the movable frame 8 to slide relative to the movable frame 8 and driving the movable frame 8 to rotate relative to the support frame 71 with the connection point between the movable frame 8 and the support frame 71 as the rotation center. This, in turn, causes the swing arm to move repeatedly, thereby swinging the second vibration assembly 5. As a result, the mounting housing of the second vibration assembly 5 can not only vibrate under the drive of the second vibration motor but also swing under the combined action of the eccentric transmission assembly 7 and the movable assembly. While ensuring user comfort, this provides users with more diversified massage modes, meets their usage needs, and delivers a better user experience.

Optionally, one end of the transmission rod 73 is provided with a fixed portion connected to the eccentric wheel 72, while the other end is provided with a sliding portion 731 slidably connected to the movable frame 8. The transmission rod 73 is securely connected to the eccentric wheel 72 through the fixed portion, with the connection point between the fixed portion and the eccentric wheel 72 being offset from the connection point between the first curved rotating shaft 41 and the eccentric wheel 72. The transmission rod 73 is slidably connected to the movable frame 8 through the sliding portion 731, while the movable frame 8 is rotatably disposed on the support frame 71. This configuration enables the following operation: when the drive motor 1 is activated, the first curved rotating shaft 41 drives the eccentric wheel 72 to rotate, causing the fixed portion of the transmission rod 73 to rotate relative to the support frame 71 with the end of the first curved rotating shaft 41 as the rotation center. Simultaneously, the transmission rod 73 transfers the kinetic energy output by the drive motor 1 to the movable frame 8, causing the sliding portion 731 of the transmission rod 73 to slide relative to the movable frame 8 and driving the movable frame 8 to rotate relative to the support frame 71 with the connecting shaft as the rotation center. This in turn drives the swing arm to move repeatedly, thereby causing the second vibration assembly 5 to swing. The connection method between the fixed part and the eccentric wheel 72 is not limited here and may be detachable or non-detachable. The movable frame 8 is provided with a sliding rail 81 for slidably connecting with the transmission rod 73; the sliding portion 731 is penetrated with a connection hole for the sliding rail 81 to pass through; the sliding portion 731 of the transmission rod 73 is slidably disposed on the sliding rail 81, enabling the sliding portion 731 to slide relative to the movable frame 8 on the sliding rail 81 and drive the movable frame 8 to rotate relative to the support frame 71, thereby causing the swing arm to repeatedly swing and making the second vibration assembly 5 oscillate.

Optionally, the massage device further comprises a telescopic rotating motor 9 disposed between the mounting seat 2 and the second vibration assembly 5. The telescopic rotating motor 9 includes a second output shaft 91 fixedly connected to the second vibration assembly 5, with the telescopic rotating motor 9 itself being fixedly connected to the mounting seat 2. The support frame 71 of the eccentric transmission assembly 7 movably abuts against the telescopic rotating motor 9. The support seat is provided with a clearance hole for the second output shaft 91 to pass through, with the second output shaft 91 being rotatably connected to the support base. The second output shaft 91 extends through the clearance hole and is fixedly connected to the eccentric wheel 72 of the eccentric transmission assembly 7. By utilizing the eccentric wheel 72 to connect the second output shaft 91 and the transmission rod 73, the connection point between the transmission rod 73 and the eccentric wheel 72 is arranged offset from the connection point between the second output shaft 91 and the eccentric wheel 72. When the telescopic rotating motor 9 is activated, the second output shaft 91 drives the eccentric cam 72 to extend and rotate, causing the connection point between the transmission rod 73 and the eccentric cam 72 to rotate relative to the support frame 71 with the second output shaft 91 as the pivot center, and moving the eccentric transmission assembly 7, the movable assembly, and the second vibration assembly 5 closer to or farther from the telescopic rotating motor 9; meanwhile, the transmission rod 73 transfers the kinetic energy output by the telescopic rotating motor 9 to the movable frame 8, causing the connection point between the transmission rod 73 and the movable frame 8 to slide relative to the movable frame 8, and driving the movable frame 8 to rotate relative to the support frame 71 with the connection point between the movable frame 8 and the support frame 71 as the pivot center, thereby repeatedly actuating the swing arm to make the second vibration assembly 5 swing; this enables the mounting housing not only to vibrate under the drive of the second vibration motor but also to achieve telescopic rotational swing under the combined action of the telescopic rotating motor 9, the eccentric transmission assembly 7, and the movable assembly; while ensuring user comfort, it provides users with more diversified massage modes, meets their usage needs, and delivers a better user experience.

### Embodiment 4

Please refer to FIGS. 1 to 5 collectively; the fourth embodiment of the present invention provides a massage device, comprising a silicone soft shell with an inner cavity and the aforementioned massage device disposed within the silicone soft shell. By encasing the outer surface of the massage device with the silicone soft shell, on one hand, the surface of the massage device becomes softer and more flexible, providing greater comfort during use; on the other hand, it provides waterproof protection, facilitating user operation and cleaning, and helps extend the service life of the massage device. The massage device obtains the required operational kinetic energy through drive motor 1, with swing mechanism 4 arranged between drive motor 1 and mounting seat 2. One end of first curved rotating shaft 41 of swing mechanism 4 is fixedly connected to first output shaft 11 of drive motor 1, while the other end penetrates second penetration hole of mounting seat 2 and is rotatably connected to mounting seat 2. When drive motor 1 starts operation, first curved rotating shaft 41 rotates with first output shaft 11, and since first curved rotating shaft 41 penetrates first penetration holes 4211 of multiple swing members 421 of first vibration assemblies 42, multiple swing members 421 sleeved on first curved rotating shaft 41 sway accordingly, causing the entire swing mechanism 4 to swing. Simultaneously, first vibration motors 422 installed in the mounting holes of swing members 421 operate and generate vibrations to massage the target area. The cylindrical shape of multiple swing members 421 ensures relatively smooth junctions between adjacent swing members 421, helping to maintain user comfort during use. By utilizing the swinging and vibration of swing mechanism 4 on the massage device in conjunction with the vibration of second vibration assembly 5 on mounting seat 2, massage is performed on the user. While ensuring user comfort, this provides more diversified massage methods to meet user needs and deliver a better user experience.

The above description represents only preferred embodiments of the present disclosure and is not intended to limit its scope. Any modifications, equivalent substitutions, and improvements made within the spirit and principles of this disclosure shall be included within its protection scope.

What is claimed is:

1. A massage device for massage equipment, characterized by comprising: a drive motor, a mounting seat, and an swing mechanism disposed between the drive motor and the mounting seat;
wherein the drive motor includes a first output shaft, the swing mechanism comprises a first curved rotating shaft and multiple first vibration assemblies disposed on the first curved rotating shaft, one end of the first curved rotating shaft being fixedly connected to the first output shaft while the other end is rotatably connected to the mounting seat; each first vibration assembly includes a cylindrical swing member sleeved on the first curved rotating shaft and a first vibration motor disposed on the swing member, the swing member being provided with a first through-hole for the first curved rotating shaft to penetrate and a mounting hole for installing the first vibration motor; the mounting seat is provided with a second through-hole for the first curved rotating shaft to penetrate, and a second vibration assembly is disposed on the side of the mounting seat opposite to the drive motor-facing side.

2. The massage device according to claim 1, characterized in that: the swing mechanism further comprises soft rubber pads disposed between adjacent swing members; the soft rubber pads are penetrated with third penetration holes for the first curved rotating shaft to pass through.

3. The massage device according to claim 1, characterized in that: the massage device further comprises a limit rod disposed between the drive motor and the mounting seat; the swing member is penetrated with a first oblong hole for the limit rod to pass through.

4. The massage device according to claim 3, characterized in that: the number of the limit rods is two, the swing member is provided with two first oblong holes penetrating therethrough, the two first oblong holes are symmetrically arranged on both sides of the first through-hole, and the two limit rods respectively penetrate through the two first oblong holes.

5. The massage device according to claim 1, characterized in that: the massage device further comprises a second curved rotating shaft; one end of the second curved rotating shaft is fixedly connected to the first curved rotating shaft, and the other end is fixedly connected to the second vibration assembly.

6. The massage device according to claim 1, characterized in that: the massage device further comprises an eccentric transmission assembly and an activity assembly disposed between the mounting seat and the second vibration assembly; the eccentric transmission assembly comprises a support frame fixed to the mounting seat, an eccentric cam fixed to the first curved rotating shaft, and a transmission rod fixed to the eccentric cam; the activity assembly comprises a movable frame rotatably disposed on the support frame and a swing arm disposed on the movable frame; the transmission rod is slidably connected to the movable frame, and the swing arm is fixedly connected to the second vibration assembly.

7. The massage device according to claim 6, characterized in that: one end of the transmission rod is provided with a fixed portion fixed to the eccentric cam, and the other end is provided with a sliding portion slidably connected to the movable frame; the movable frame is provided with a sliding rail for slidably connecting with the transmission rod; the sliding portion is penetrated with a connection hole for the sliding rail to pass through.

8. The massage device according to claim 1, characterized in that: the massage device further comprises a telescopic rotating motor arranged between the mounting seat and the second vibration assembly, wherein the telescopic rotating motor has a second output shaft fixedly connected to the second vibration assembly.

9. The massage device according to claim 1, characterized in that: the second vibration assembly comprises a mounting housing fixed to the mounting seat and a second vibration motor disposed within the mounting housing.

10. A massage equipment, characterized by: comprising a silicone soft shell with an inner cavity and the massage device according to claim 1 disposed within the silicone soft shell.
